(19) United States
(12) Patent Application Publication
(10) Pub. No.: US 2020/0115166 A1
(43) Pub. Date: Apr. 16, 2020

(54) Production Packaging Inkjet Detection Apparatus

(71) Applicant: Chun Liu, Foshan City (CN)

(72) Inventor: Chun Liu, Foshan City (CN)

(21) Appl. No.: 16/711,447

(22) Filed: Dec. 12, 2019

(30) Foreign Application Priority Data
Sep. 18, 2019 (CN) 2019108819146

(51) Int. Cl. B65G 43/08; G06T 7/00

(52) U.S. Cl. CPC B65G 43/08; B65G 2201/02; G06T 7/0002

(57) ABSTRACT

The invention discloses a production package inkjet detection device, which includes a support table. The upper end surface of the support table is provided with two transmission belts. The upper end surface of the support table is also fixed with a support block. A pushing mechanism for the detected product to move to the right or left, and the supporting platform is further provided with a rotating mechanism that can rotate the product to be detected. The rotating mechanism includes a rotating cavity on the front side of the upper end wall that communicates with the external space. A driven shaft is rotatably connected to the lower end wall of the rotating cavity, and a rotating platform capable of supporting the product is fixed at the upper end of the driven shaft.

### CROSS-REFERENCES TO RELATED APPLICATIONS

The present application claims priority from Chinese application No. 2019108819146 filed on Sep. 18, 2019 which is hereby incorporated by reference in its entirety.

### FIELD OF TECHNOLOGY

The invention relates to the field of detecting, and in particular relates to a production packaging inkjet detection apparatus.

### TECHNICAL FIELD

The product needs to be packaged when it leaves the factory, and after the packaging is completed, coding is required on the packaging to mark each product. In the coding process, leakage or incomplete coding will inevitably occur.

At the current stage, when testing inkjet codes, some are manually inspected, which is extremely labor-intensive and inefficient, while others are spot-tested, which easily misses some defective products and reduces product quality.

### CONTENT OF THE INVENTION

The technical problem to be solved by the present invention is to provide a production packaging inkjet detection device, which overcomes the problems of low manual detection efficiency and the like, and improves work efficiency. The present invention is achieved by the following technical solutions.

The invention is a production packaging inkjet detection device, which includes a support table, the upper end surface of the support table is provided with two transmission belts, the upper end surface of the support table is also fixed with a support block, and the support block is provided with a driving detection device. The finished product is moved to the right or left by the pushing mechanism; a rotation mechanism capable of driving the product to be detected is also provided in the support table. The rotation mechanism includes a rotation cavity on the front side of the upper end wall that communicates with the external space, and a driven shaft is rotatably connected to the lower end wall of the rotation cavity. A rotating platform supporting the product is fixed at the upper end of the moving shaft, a rotating gear is fixed at the lower end of the driven shaft, a driving motor is fixed at the lower end wall of the rotating cavity, and a driving shaft is connected to the upper end of the driving motor. The upper end is fixed with a first semicircular gear that can be meshed with the rotating gear. The upper end of the drive shaft is also fixed with a second semicircular gear. The lower end wall of the rotating cavity is also rotatably connected with a transmission shaft. The lower end wall of the rotating cavity is connected by a torsion spring. The upper end of the transmission shaft is fixed with a transmission gear that can mesh with the second semicircular gear. The transmission shaft is also fixed with a rope winding wheel. The support block is provided with A lifting cavity with an opening forward, the lifting cavity is provided with a lifting block and a lifting spring connecting the lifting block and the upper end wall of the lifting cavity, and a rear end winding is wound on the rope reel The rear end wall of the rotating cavity and the upper end wall of the lifting cavity are fixedly connected with the lifting chain. The front end of the lifting block is fixed with a fixing rod whose front end is located in the external space, and the front end of the fixing rod is fixed with a fixing plate. A detection scanner is fixed at the front end of the fixed plate; the support block is provided with a rotation mechanism that can prevent the product from moving to the right, and the support block is also provided with a movement mechanism that drives the rotation mechanism and the pushing mechanism to move. The product to be tested is brought to the destination by the transmission. When the rotating platform is on the upper side, the rotating mechanism works to detect the product, and after the detection, the moving mechanism is controlled to work according to the detection result, so that the pushing mechanism works to drive the separated product to move, which realizes automatic detection and improves efficiency.

Further, the pushing mechanism includes a sliding cavity with an opening forward, the sliding cavity is provided with a sliding block and a sliding spring connecting the sliding block with the right end wall of the sliding cavity. A connecting block in the external space, a connecting post is fixed at the front end of the connecting block, and a rotating groove with an opening to the right and a lower end wall communicating with the external space is arranged in the lower end of the connecting column, and a rotating shaft is fixed between the front and rear walls of the rotating groove The rotating shaft is rotatably connected with a rotating rod whose lower end is located in the external space. The support block is further provided with a pushing cavity which is opened forward. The pushing cavity is provided with a pushing rod whose front end is located in the external space. The upper end of the push rod is fixed with a rack plate whose front end is located in the external space. The front end of the push rod is fixed with a push plate that can push the product with unqualified coding forward. The right end wall of the push cavity is connected with a push. A pusher gear whose upper end meshes with the rack plate is fixed at the left end of the pusher shaft, a connecting gear is meshed with the lower end of the pusher gear, and a transmission gear is arranged in the right end wall of the pusher cavity Cavity, the connecting gear center is fixed with a connecting shaft with a right end located in the transmission cavity, a first bevel gear is fixed with a right end of the connecting shaft, and a winding shaft is rotatably connected with the rear end wall of the transmission cavity, and the winding A winding wheel and a second bevel gear are fixed on the shaft, and the winding wheel is wound with a rope whose lower end penetrates the lower end wall of the transmission cavity and the right end wall of the sliding cavity and is fixedly connected to the sliding block.

Further, the rotation mechanism includes a rotation cavity opened forward, and the right end wall of the rotation cavity is rotatably connected with a left end penetrating the left end wall of the rotation cavity and the right end wall of the transmission cavity and located in the transmission cavity. A rotating rod whose front end is located in the external space is fixed at the right end of the rotating shaft, and a third bevel gear is fixed at the left end of the rotating shaft.

Further, the moving mechanism includes an L-shaped moving cavity, and a moving block is slidably connected in the moving cavity. A lower end wall of the moving cavity communicates with the transmission cavity. A motor is disposed in the moving block and a lower end of the motor is provided. A power shaft having a lower end located in the transmission cavity is connected to the power, a fourth bevel gear meshing with the third bevel gear is fixedly connected to the lower end of the power shaft, a rear wall of the moving cavity and a left end of the moving cavity Each of the wall rods is provided with an electromagnet controlled by the detection scanner, and one end of the electromagnet is fixed with a moving spring that is in contact with the moving block at one end.

Further, the magnetic force between the electromagnet and the moving block is much larger than the elastic force of the moving spring.

Further, the sum of the elastic force of the torsion spring and the lift spring is much larger than the sum of the gravity of the lift block, the fixed rod, and the fixed plate. In the initial state, the torsion spring and the lift The spring is in a normal tension state, and the sum of the gravity of the lifting block, the fixing rod, and the fixing plate is greater than the elastic force of the lifting spring.

Further, when the first semicircular gear rotates to mesh with the rotating gear, the second semicircular gear will not mesh with the first semicircular gear, and the arc angle of the first semicircular gear is ninety degrees, The arc angle of the second semicircular gear is 270 degrees.

Further, the elastic force of the sliding spring is far greater than the frictional force between the sliding block and the sliding cavity.

Further, in the initial state, the fourth bevel gear and the third bevel gear are in a meshing state.

The beneficial effect of the invention is that the device has a simple structure and convenient operation. The device quickly detects and separates packaging products that have no coding or incomplete coding. Through mechanical transmission, the detection efficiency is improved. It is fully automatic and requires no manual assistance. Operation, reducing the workload of workers.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic structural diagram of an embodiment of the present invention;

FIG. 2 is a schematic diagram A-A in FIG. 1 according to an embodiment of the present invention;

FIG. 3 is a schematic diagram B-B in FIG. 1 according to an embodiment of the present invention;

FIG. 4 is a schematic diagram of C-C in FIG. 1 according to an embodiment of the present invention;

FIG. 5 is a schematic top plan view of the second semicircular gear in FIG. 1 according to the embodiment of the present invention; FIG.

FIG. 6 is a schematic top plan view of the first semicircular gear in FIG. 2 according to the embodiment of the present invention.

### DETAILED DESCRIPTION OF THE INVENTION

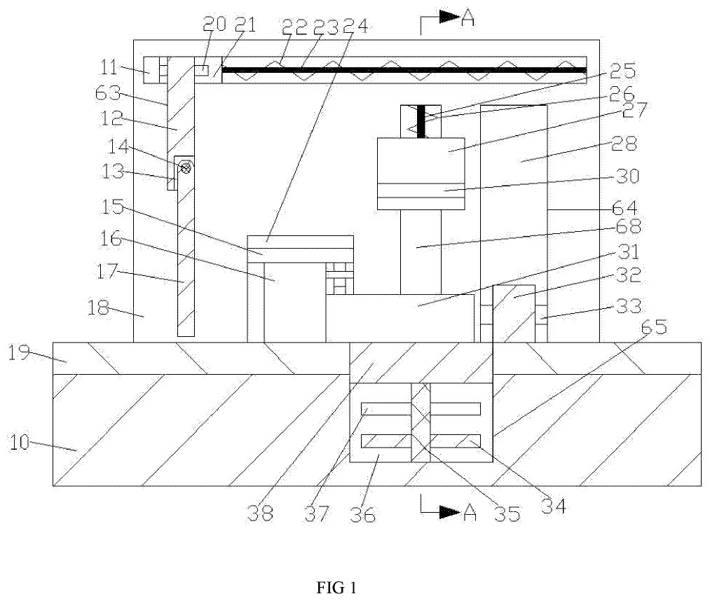

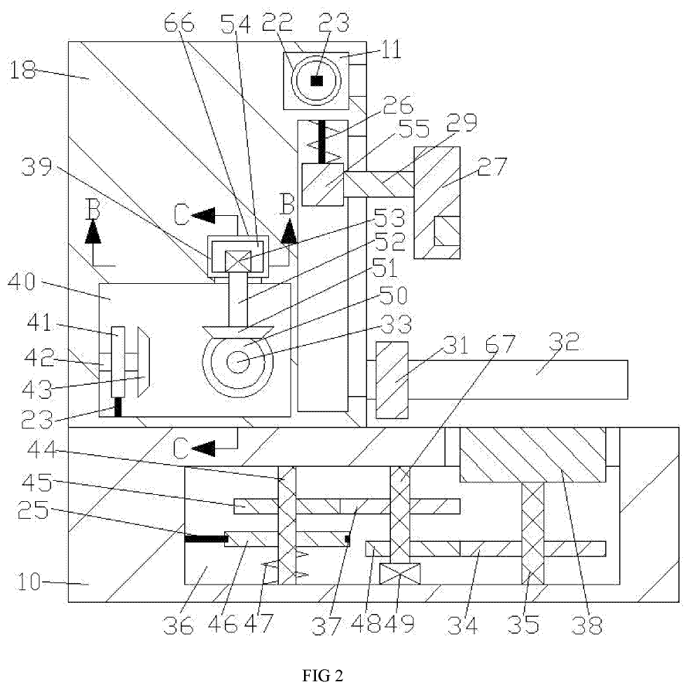

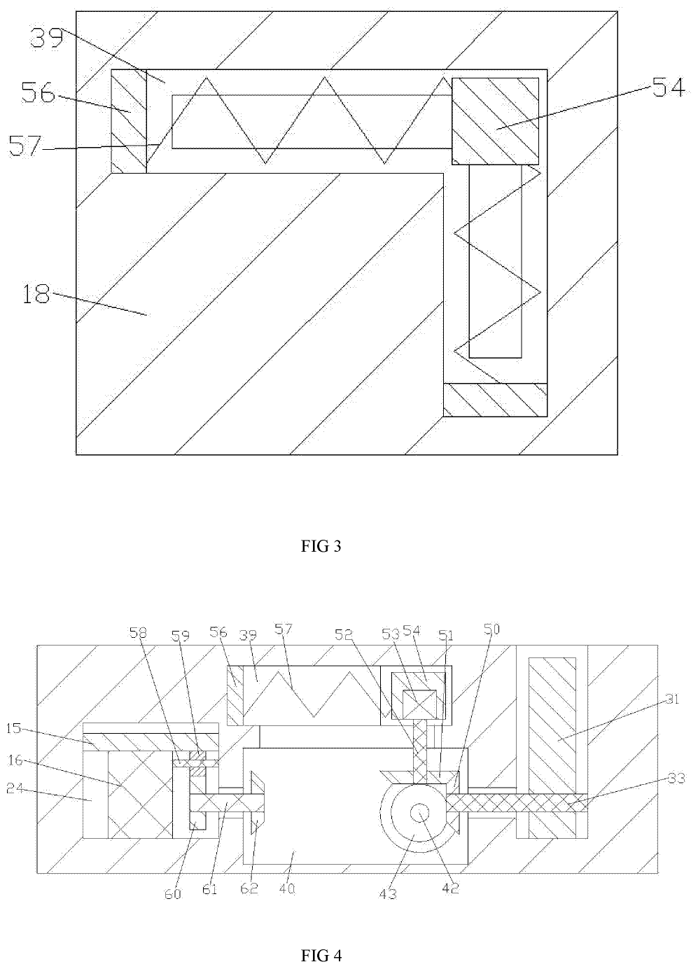

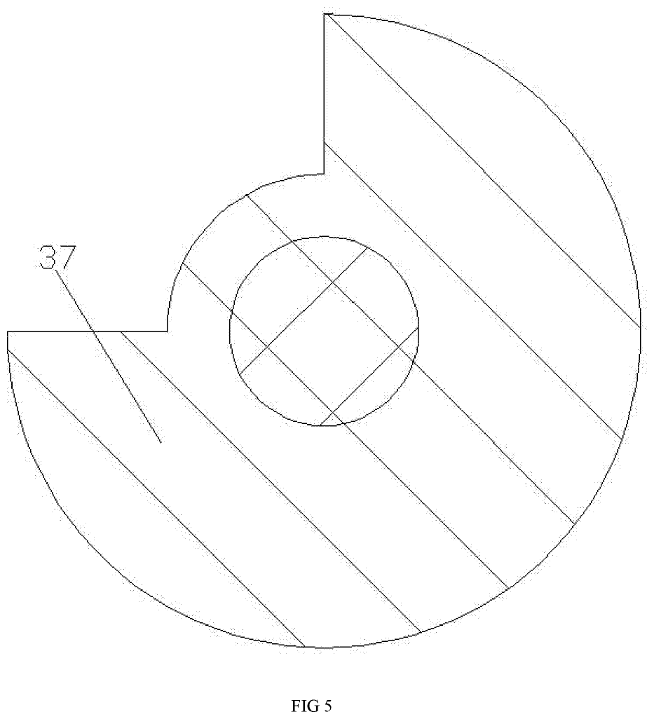

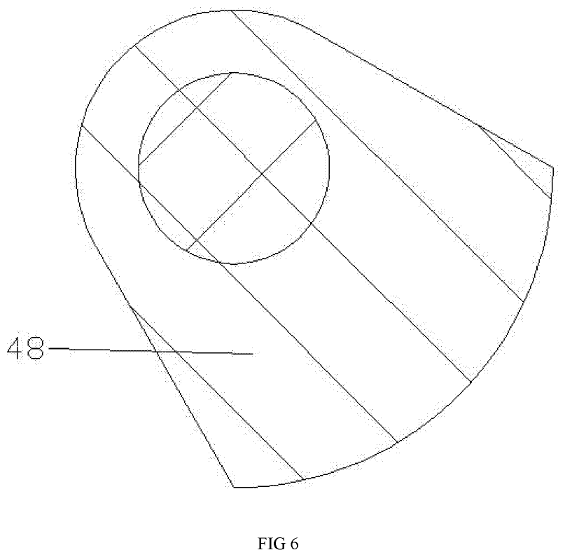

The present invention is described in detail below with reference to FIGS. 1-6. For convenience of description, the orientation described below is defined as follows: the up-down, left-right, front-back direction described below is consistent with the up-down, left-right, front-back direction of the projection relationship of FIG. 1 itself.

A production packaging inkjet detection device described with reference to FIGS. 1-6 includes a support table 10, and the upper end surface of the support table 10 is provided with two transmission belts 19. The upper end surface of the support table 10 is further fixed with a support block 18. The supporting block 18 is provided with a pushing mechanism 63 that can move the detected product to the right or left, and the supporting table 10 is also provided with a rotating mechanism 65 that can rotate the product to be detected. The rotating mechanism 65 includes a rotating cavity 36 communicating with the external space on the front side of the upper end wall, and a driven shaft 35 is rotatably connected to the lower end wall of the rotating cavity 36, and a rotating platform 38 capable of supporting the product is fixed at the upper end of the driven shaft 35. A rotating gear 34 is fixed at the lower end of the shaft 35, and a driving motor 49 is also fixed at the lower end wall of the rotating cavity 36. A driving shaft 67 is connected to the upper end of the driving motor 49, and an upper end of the driving shaft 67 is fixed to the rotating gear. 34 meshing first semicircular gear 48, a second semicircular gear 37 is also fixed at the upper end of the driving shaft 67, and a transmission shaft 44 is rotatably connected to the lower end wall of the rotation cavity 36, and the lower end of the transmission shaft 44 and the rotation cavity 36 between the lower end wall by torsion spring 47 connection, an upper end of the transmission shaft 44 is fixed with a transmission gear 45 that can be engaged with the second semicircular gear 37, a winding rope wheel 46 is also fixed on the transmission shaft 44, and an opening direction is provided in the support block 18. The front lifting chamber 68 is provided with a lifting block 55 and a lifting spring 26 connecting the lifting block 55 and the upper end wall of the lifting chamber 68. The rope winding wheel 46 is wound with a rear end penetrating through The rear end wall of the rotating cavity 36 and the upper end wall of the lifting cavity 68 are fixedly connected with the chain 25 which is fixed to the lifting block 55. The front end of the lifting block 55 is fixed with a fixing rod 29 whose front end is located in the external space. A fixing plate 27 is fixed at the front end of the fixing plate 27, and a detection scanner 30 is fixed at the front end of the fixing plate 27. A rotation mechanism 64 is provided in the support block 18 to prevent the product from moving to the right, and a drive is also provided in the support block 18. When the rotating mechanism 64 and the moving mechanism 66 of the pushing mechanism 63 move, when the product to be tested reaches the upper side of the rotating platform 38 through the transmission belt 19, the rotating mechanism 65 works to detect the product. As a result, the movement mechanism 66 is controlled to operate, thereby The pushing mechanism 63 works to separate the detected products from movement, realize automatic detection and improve efficiency.

Beneficially, the pushing mechanism 63 includes a sliding cavity 11 opened forward, and a sliding block 21 and a sliding spring 22 connecting the sliding block 21 and the right end wall of the sliding cavity 11 are provided in the sliding cavity 11. The front end of the sliding block 21 is fixed with a connection block 20 whose front end is located in the external space. The front end of the connection block 20 is fixed with a connection post 12. The lower end of the connection post 12 is provided with a rotation groove 13 which opens to the right and the lower end wall communicates with the external space. A rotating shaft 14 is fixed between the front and rear walls of the rotating groove 13. The rotating shaft 14 is rotatably connected with a rotating rod 17 whose lower end is located in the external space. The support block 18 is also provided with an opening forward pushing cavity. 24. The pushing cavity 24 is provided with a pushing rod 16 whose front end is located in the external space. A rack plate 15 whose front end is located in the external space is fixed at the upper end of the pushing rod 16. A pushable belt is fixed at the front end of the pushing rod 16. There is a pushing plate 31 with a non-conforming product moving forward, a right end wall of the pushing cavity 24 is rotatably connected with a pushing shaft 58, and a pushing gear 59 with an upper end meshing with the rack plate 15 is fixed at the left end of the pushing shaft 58. The lower end of the pushing gear 59 A connecting gear 60 is incorporated, and a driving cavity 40 is provided in the right end wall of the pushing cavity 24. The connecting gear 60 is fixed at its center with a connecting shaft 61 having a right end located in the driving cavity 40, and a right end of the connecting shaft 61 is fixed with a first A bevel gear 62, a winding shaft 42 is rotatably connected to the rear wall of the transmission cavity 40, a winding wheel 41 and a second bevel gear 43 are fixed on the winding shaft 42, and the winding wheel 41 is wound around The lower end of the rope 23 passes through the lower end wall of the transmission cavity 40 and the right end wall of the sliding cavity 11 and is fixedly connected to the sliding block 21.

Beneficially, the rotation mechanism 64 includes a rotation cavity 28 opened forward, and a right end wall of the rotation cavity 28 is rotatably connected with a left end penetrating through the left end wall of the rotation cavity 28 and the right end wall of the transmission cavity 40 and located in the transmission cavity. A rotating shaft 33 in 40 is fixed to the right end of the rotating shaft 33 with a rotating rod 32 having a front end located in the external space, and a third bevel gear 50 is fixed to the left end of the rotating shaft 33.

Advantageously, the moving mechanism 66 includes an L-shaped moving cavity 39 in which a moving block 54 is slidably connected, and a lower end wall of the moving cavity 39 communicates with the transmission cavity 40, and the moving block 54 is provided inside There is a motor 53, a lower end of the motor 53 is power-connected with a power shaft 52 having a lower end located in the transmission cavity 40, and a fourth bevel gear 51 meshed with the third bevel gear 50 is fixedly connected to the lower end of the power shaft 52, An electromagnet 56 controlled by the detection scanner 30 is provided in the rear wall of the mobile cavity 39 and the left end wall of the mobile cavity 39. One end of the electromagnet 56 is fixed to the mobile block 54 at one end. Contact the moving spring 57.

Advantageously, the magnetic force between the electromagnet 56 and the moving block 54 is much larger than the elastic force of the moving spring 57.

Beneficially, the sum of the elastic force of the torsion spring 47 and the lift spring 26 is much larger than the sum of the gravity of the lift block 55, the fixing rod 29, and the fixing plate 27. In the initial state, the torsion The spring 47 and the lifting spring 26 are in a normal tension state, and the sum of the gravity of the lifting block 55, the fixing rod 29 and the fixing plate 27 is greater than the elastic force of the lifting spring 26.

Advantageously, when the first semi-circular gear 48 rotates to mesh with the rotating gear 34, the second semi-circular gear 37 will not mesh with the first semi-circular gear 48, and the arc angle of the first semi-circular gear 48 The arc angle of the second semicircular gear 37 is two hundred and seventy degrees.

Advantageously, the elastic force of the sliding spring 22 is much larger than the frictional force between the sliding block 21 and the sliding cavity 11.

Advantageously, in the initial state, the fourth bevel gear 51 and the third bevel gear 50 are in an engaged state.

The sequence of mechanical actions of the entire device:

1: When the left transmission belt 19 transports the product to be tested to the upper side of the rotating platform 38, the motor 53 works to rotate the power shaft 52, so that the fourth bevel gear 51 and the third bevel gear 50 are rotated, so that the rotation shaft 33 Rotate, so that the rotation lever 32 is rotated, so that one end of the rotation shaft 33 is located on the right side of the rotation platform 38 to prevent the product from leaving the upper side of the rotation platform 38. When the product remains stably on the upper side of the rotation platform 38, the motor 53 works so that The power shaft 52 is reversed, so that the fourth bevel gear 51 and the third bevel gear 50 are reversed, so that the rotating shaft 33 and the rotating rod 32 are reset. At this time, the driving motor 49 works to drive the driving shaft 67 to rotate. At this time, the first semicircle The gear 48 first meshes with the rotation gear 34, and the driving shaft 67 rotates to drive the first semicircular gear 48 to rotate, thereby driving the rotation gear 34 to rotate, thereby driving the driven shaft 35 and the rotation platform 38 to rotate, and the first semicircular gear 48 rotates and rotates the gear 34 When separated, the rotating platform 38 just rotates ninety degrees. At this time, the second semicircular gear 37 starts to mesh with the transmission gear 45. The rotation of the driving shaft 67 drives the second semicircular gear 37 to rotate, thereby driving the transmission gear 45. It will drive the drive shaft 44 to rotate, so that the reel 46 will be rotated and the torsion spring 47 will be twisted. The rotation of the reel 46 will relax the chain 25, so that the lifting block 55, the fixing rod 29 and the fixing plate 27 are under their own weight. Under the action, the lifting spring 26 is stretched, and the fall of the fixed plate 27 drives the detection scanner 30 to descend, so that the detection scanner 30 scans and detects one side of the product;

2: When the second semi-circular gear 37 rotates and separates from the transmission gear 45, the first semi-circular gear 48 just happens to mesh with the rotary gear 34 again, and at this time, the fixed plate 27 is lowered to the lowest side to complete scanning of one side of the product It is detected that the second semicircular gear 37 is separated from the transmission gear 45, the torsion spring 47 and the lifting spring 26 are reset, and the reset of the torsion spring 47 drives the transmission shaft 44 to rotate and reset, thereby driving the rope reel 46 to rotate, thereby tightening the chain 25, thereby making The lifting block 55, the fixing rod 29 and the fixing plate 27 are raised and reset, and at this time, the driving shaft 67 continues to rotate until the detection scanner 30 completes the detection of the four sides of the product;

3: According to the detection result of the detection scanner 30, if the detection printing is qualified, the detection scanner 30 controls the operation of the electromagnet 56 on the rear side, and the electromagnet 56 on the rear side attracts the moving block 54 to make the moving block 54 backward. The movement, the rear side moving spring 57 is compressed, the movement of the moving block 54 drives the motor 53 to move backward, thereby driving the power shaft 52 and the fourth bevel gear 51 to move backward. When the moving block 54 moves to the rear side, the fourth cone The gear 51 meshes with the second bevel gear 43. At this time, the motor 53 works to drive the power shaft 52 to rotate, so that the fourth bevel gear 51 and the second bevel gear 43 are rotated, so that the winding shaft 42 and the winding wheel 41 are rotated. Tighten the rope 23, so that the sliding block 21 moves to the right, the sliding spring 22 is compressed, the sliding block 21 moves to the right to drive the connecting column 12 and the rotating rod 17 to move to the right, and the rotating rod 17 contacts the product in the process of moving to the right. Then the product is driven to the right, so that the product moves from the upper side of the rotating platform 38 to the upper side of the right transmission belt 19, and then the rear electromagnet 56 stops working, and the rear movement spring 57 reset drives the moving block 54 to move forward, thereby Make the fourth bevel gear 51 is separated from the second bevel gear 43. At this time, the slide spring 22 is reset to drive the slide block 21 to move to the left, and the rope 23 is pulled to relax;

4: If the printing code is not qualified, the detection scanner 30 controls the operation of the left electromagnet 56. The left electromagnet 56 attracts the moving block 54 to move the moving block 54 to the left and the left moving spring 57 is Compression, the movement of the moving block 54 drives the motor 53 to the left, thereby driving the power shaft 52 and the fourth bevel gear 51 to the left. When the moving block 54 moves to the left, the fourth bevel gear 51 and the first bevel gear 62 is engaged, at this time, the motor 53 works to drive the power shaft 52 to rotate, thereby driving the fourth bevel gear 51 and the first bevel gear 62 to rotate, thereby driving the connecting shaft 61 and the connecting gear 60 to rotate, thereby driving the pushing shaft 58 and the pushing gear 59 to rotate Therefore, the rack plate 15 is driven to move forward, so that the push rod 16 and the push plate 31 are moved forward, so that the unqualified products leave the upper side of the rotating platform 38 and are separated, and then the motor 53 works to drive the power shaft 52 Reverse, drive the driving gear 59 to reverse by transmission, so that the rack plate 15 and the push rod 16 are moved backward to reset, so that the push plate 31 is reset to move backward. After the push plate 31 is reset, the motor 53 stops working. Side electromagnetic 56 stops working, the left-side moving spring 57 resets and moves the moving block 54 to the right to reset, so that the fourth bevel gear 51 is separated from the first bevel gear 62, and the left transmission belt 19 transports the product to be tested to the rotating platform 38 again When the device works again.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A production packaging inkjet detection device includes a support table, which is characterized in that: two transmission belts are provided on the upper end surface of the support table; a support block is also fixed on the upper end surface of the support table; Pushing mechanism of the detected product moving to the right or left; a rotation mechanism capable of driving the product to be detected is also provided in the support table. The rotation mechanism includes a rotation cavity on the front side of the upper end wall that communicates with the external space, and a driven shaft is rotatably connected to the lower end wall of the rotation cavity. A rotating platform supporting the product is fixed at the upper end of the moving shaft, a rotating gear is fixed at the lower end of the driven shaft, a driving motor is fixed at the lower end wall of the rotating cavity, and a driving shaft is connected to the upper end of the driving motor. The upper end is fixed with a first semicircular gear that can be meshed with the rotating gear. The upper end of the drive shaft is also fixed with a second semicircular gear. The lower end wall of the rotating cavity is also rotatably connected with a transmission shaft. The lower end wall of the rotating cavity is connected by a torsion spring. The upper end of the transmission shaft is fixed with a transmission gear that can mesh with the second semicircular gear. The transmission shaft is also fixed with a rope winding wheel. The support block is provided with A lifting cavity with an opening forward, the lifting cavity is provided with a lifting block and a lifting spring connecting the lifting block and the upper end wall of the lifting cavity, and a rear end winding is wound on the rope reel The rear end wall of the rotating cavity and the upper end wall of the lifting cavity are fixedly connected with the lifting chain. The front end of the lifting block is fixed with a fixing rod whose front end is located in the external space, and the front end of the fixing rod is fixed with a fixing plate. A detection scanner is fixed at the front end of the fixed plate; the support block is provided with a rotation mechanism that can prevent the product from moving to the right, and the support block is also provided with a movement mechanism that drives the rotation mechanism and the pushing mechanism to move. The product to be tested is brought to the destination by the transmission. When the rotating platform is on the upper side, the rotating mechanism works to detect the product, and after the detection, the moving mechanism is controlled to work according to the detection result, so that the pushing mechanism works to drive the separated product to move, which realizes automatic detection and improves efficiency.

2. The apparatus for detecting coding of a production package according to claim 1, wherein the pushing mechanism includes a sliding cavity opening forward, and a sliding block is provided in the sliding cavity and the sliding block is connected to the sliding block. A sliding spring at the right end wall of the sliding cavity. The front end of the sliding block is fixed with a connecting block whose front end is located in the external space. The front end of the connecting block is fixed with a connecting post. A rotating groove in the space, a rotating shaft is fixed between the front and rear walls of the rotating groove, a rotating rod whose lower end is located in the external space is rotatably connected to the rotating shaft, and a pushing cavity with an opening forward is also provided in the support block, The push cavity is provided with a push rod whose front end is located in the external space, a rack plate whose front end is located in the external space is fixed at the upper end of the push rod, and the front end of the push rod is fixed with a product which can push the unqualified code. A pushing plate moving forward, a pushing shaft is rotatably connected to the right end wall of the pushing cavity, and a pushing gear whose upper end is meshed with the rack plate is fixed at the left end of the pushing shaft. A connection gear is engaged at the lower end of the wheel, a transmission cavity is arranged in the right end wall of the pushing cavity, a connection shaft with a right end located in the transmission cavity is fixed at the center of the connection gear, and a first bevel gear is fixed at the right end of the connection shaft. A winding shaft is rotatably connected to the rear end wall of the transmission cavity. A winding wheel and a second bevel gear are fixed on the winding shaft. A lower end of the winding wheel is wound through the lower end wall of the transmission cavity and the slide. A rope at the right end wall of the cavity and fixedly connected to the sliding block.

3. The apparatus for detecting coding of a production package according to claim 1, wherein the rotation mechanism comprises a rotation cavity opening forward, and a right end wall of the rotation cavity is rotatably connected with a left end penetrating the left end wall of the rotation cavity and A rotating shaft at the right end wall of the transmission cavity and located in the transmission cavity, a rotating rod whose front end is located in the external space is fixed at the right end of the rotating shaft, and a third bevel gear is fixed at the left end of the rotating shaft.

4. The coding and detection device for production packaging according to claim 3, wherein the moving mechanism comprises an L-shaped moving cavity, a moving block is slidably connected in the moving cavity, and a lower end wall of the moving cavity communicates with the In the transmission cavity, a motor is provided in the moving block, and a lower end of the motor is connected to a power shaft with a lower end located in the transmission cavity. The bevel gear is provided with an electromagnet controlled by the detection scanner in the rear wall of the mobile cavity and the left end wall of the mobile cavity. One end of the electromagnet is fixed with one end in contact with the moving block. spring.

5. The apparatus for detecting coding of a production package according to claim 4, wherein the magnetic force between the electromagnet and the moving block is much larger than the elastic force of the moving spring.

6. The production package inkjet detection device according to claim 1, wherein the sum of the elastic force of the torsion spring and the elastic force of the lifting spring is much larger than the lifting block, the fixing rod, and the fixing The sum of the gravity of the plate, the torsion spring and the lifting spring are in a normal stretched state in the initial state, and the sum of the gravity of the lifting block, the fixing rod and the fixing plate is greater than the elastic force of the lifting spring.

7. The production packaging inkjet detection device according to claim 1, wherein, when the first semicircular gear rotates and meshes with the rotary gear, the second semicircular gear and the first semicircular gear will not Meshing, the arc angle of the first semicircular gear is ninety degrees, and the arc angle of the second semicircular gear is 270 degrees.

8. The production package inkjet detection device according to claim 2, wherein the elastic force of the sliding spring is much greater than the friction between the sliding block and the sliding cavity.

9. The apparatus for detecting coding of a production package according to claim 4, characterized in that, in an initial state, the fourth bevel gear and the third bevel gear are in an engaged state.
